(19) United States
(12) Patent Application Publication
(10) Pub. No.: US 2005/0059911 A1
(43) Pub. Date: Mar. 17, 2005

(54) Centrifugal, rotating power element and a massaging device using the same

(76) Inventor: Pin-Hung Lin, Taipei City (TW)

Correspondence Address: Pin-Hung Lin, PO Box 82-144, Taipei, TW

(21) Appl. No.: 10/663,837

(22) Filed: Sep. 17, 2003

(51) Int. Cl. A61H 1/00; A61H 23/02

(52) U.S. Cl. 601/70; 601/71

(57) ABSTRACT

A centrifugal, rotating power element and a massaging device using the same, which is characterized in that the driving shaft is provided with a swinging member having a root section and an end section and the weight of the root section and that of the end section are of certain ratio, and the root section and the end section are connected flexibly such that when the driving shaft rotates, the end portion of the swinging element is provided with an appropriate torsional swinging force as a result of the centrifugal force. The massaging device employs the power element comprising a mask body having a front and a rear plate, a securing plate being mounted to the mask body for mounting a securing seat and the power element, and a plurality of securing seat mounted at the mask body for mounting a plurality of the power elements and two binding straps mounted at the two lateral sides of the rear plate of the mask body; and a controller having one end connected to a conductive wire and the mask body.

### BACKGROUND OF THE INVENTION

(a) Technical Field of the Invention

The present invention relates to a power element and the use of the power element in a massaging device, and in particular, to a power element having a motor mounted with a swing element on the driving shaft of the motor. The power element is used in a massaging device such that the massaging force can be adjusted.

(b) Description of the Prior Art

Taiwanese Patent Publication No. 109195, entitled “A Massaging Spectacle” and Taiwanese Patent Publication No. 366803, entitled “An Improved Structure of A Massaging Spectacle” disclose spectacle with a motor to provide vibration motion and the inner side of the spectacle frame is provided with a plurality of protrusions. In application, the motor drives an eccentric block to rotate so that the entire spectacle frame generates a light vibration and the protrusions massaging the contact portion. However, with respect to structure, there are drawbacks such as: (1) the eccentric block does not allow flexible swinging action and therefore the vibration point is a fix position and the effect of massaging is merely a point massaging; (2) the spectacle frame is a non flexible structure and only the portion adhered to the eye is an arch shape and therefore it is not convenient in storage, (3) the motor is only positioned at the center of the spectacle frame and therefore the vibration effect is at the different at each part of the spectacle frame. In other words, the massaging effect is not a full massaging effect. In view of the above, it is an object of the present invention to provide a centrifugal, rotating power element, which can mitigate the above drawbacks.

### SUMMARY OF THE INVENTION

Accordingly it is an object of the present invention to provide a centrifugal, rotating power element comprising a motor having a driving shaft, characterized in that the driving shaft is provided with a swinging member having a root section and an end section and the weight of the root section and that of the end section are of certain ratio, and the root section and the end section are connected flexibly such that when the driving shaft rotates, the end portion of the swinging element is provided with an appropriate torsional swinging force as a result of the centrifugal force.

Yet another object of the present invention is to provide a centrifugal, rotating power element, wherein electronic control is used to change the voltage of the motor so as to change the rotational speed of the driving shaft in order to change the centrifugal force of the swinging element to adjust the massaging force.

Still another object of the present invention is to provide a centrifugal, rotating power element, wherein a plurality of distribution type of centrifugal, rotating power elements are mounted to the mask body and an electronically control controller is used to form alternately and fluctuating operation and massaging force.

Still yet another object of the present invention is to provide a massaging device using the centrifugal, rotating power element of the present invention, wherein a flexible mask body is mounted to the massaging device so as to closely adhere to the parts of the body.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of the rotating power element of the present invention.

FIGS. 2A, 2B, 2C are schematic views showing the stationary and rotating state of the power element of the present invention.

FIGS. 3A, 3B, 3C, 3D are schematic views showing rotating power element in accordance with the present invention.

FIG. 4 is a sectional schematic view showing the front of the swinging element of the power element of the present invention.

FIG. 5 is a perspective view of the massaging device using the power element of the present invention.

FIG. 6 is a perspective exploded view of the power element of FIG. 5 of the present invention.

FIG. 7 is a perspective exploded view of the motor securing seat in accordance with the present invention.

FIG. 8 is a sectional view of the massaging device in accordance with the present invention.

FIG. 9 is a sectional view of the massaging device viewed from the top, in accordance with the present invention.

FIGS. 10 to 12 show different arrangements of the rotating power element in accordance with the present invention.

FIG. 13 is a schematic view of massaging device showing the protrusion massaging the eye portion in accordance with the present invention.

FIG. 14 is a schematic view of the power element with anti-shock element of the present invention.

FIG. 15 is another schematic view of the power element with anti-shock element of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

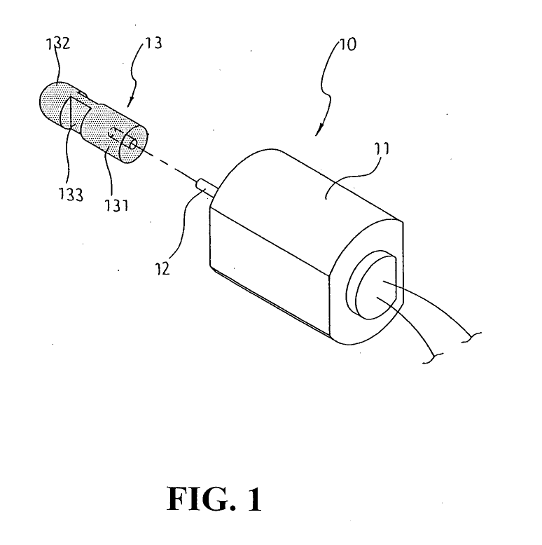

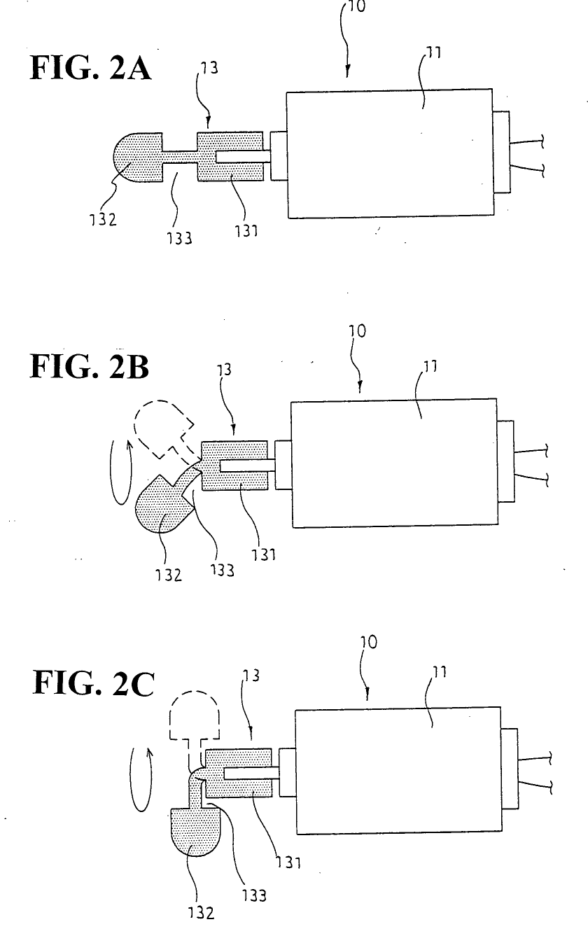

Referring to FIGS. 1 and 2A there is shown a centrifugal, rotating power element 10 having a motor 11 with a driving shaft 12. The shaft 12 is mounted with a swinging element 13 having a root section 131 and an end section 132. The weight of the root section 131 and the end section 132 is in a specific ratio such that the end section 132 is driven by the driving shaft 12 to rotate to provide a centrifugal motion. There is a connection connecting the end section 132 and the root section 131. A notch 133 is formed on the connection. The material for forming the swinging element 13 is made from rubber and therefore the end section 132 is a flexible structure.

Referring to FIGS. 2B and 2C, when the driving shaft 12 rotates the end section 132 is provided with an appropriate torsional force and the torsional force can be employed as vibrating messaging force. By employing an electronic controller to control the voltage of the motor 11, the speed of the driving shaft 12 is changed and therefore the centrifugal force of the swinging element 13 is changed and the strength of the massaging force is adjusted. As shown in FIG. 2B, when the rotating speed of the driving shaft 12 rotates slower, the swinging centrifugal force of the swinging element 13 is smaller. FIG. 2C shows when the speed of the driving shaft 12 is faster, the centrifugal force is larger.

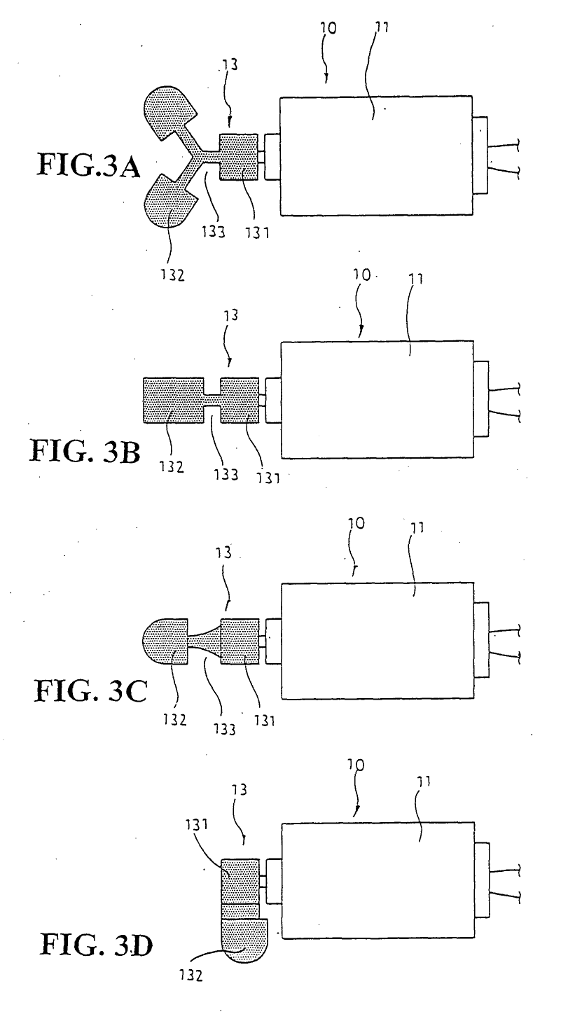

Referring to FIGS. 3A, 3B, 3C, 3D, the shapes of the swinging element 13 can be varied. As shown in FIG. 3A, the end section 132 of the swinging element 13 can be made with two head-like structures so as to increase the centrifugal force of the swinging element 13.

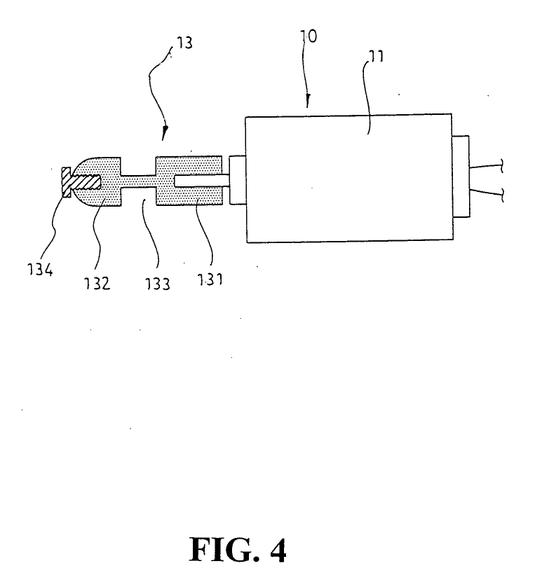

Referring to FIG. 4, a screw hole can be made at the end section 132 of the swinging element 13 so as to add a weight body 134. This will also increase the centrifugal force of the swinging element 13.

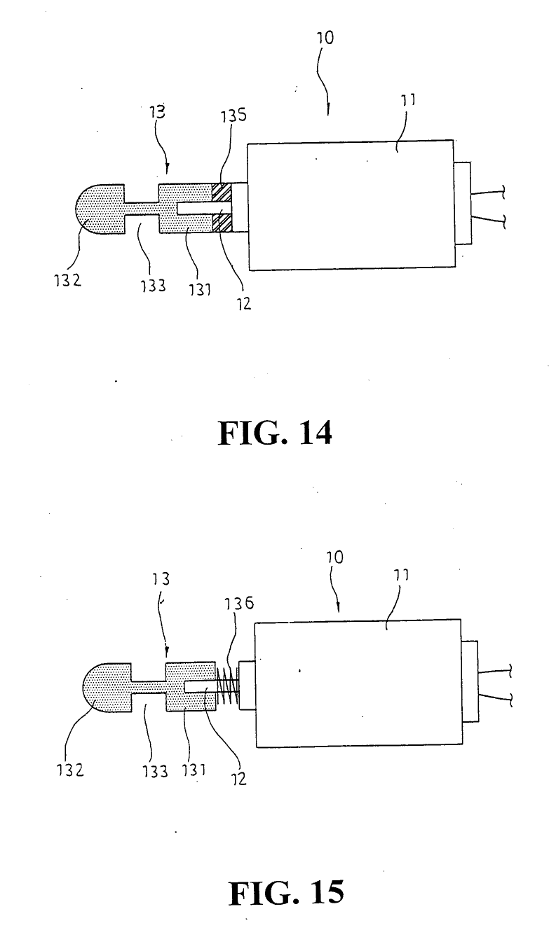

As shown in FIGS. 14 and 15, the swinging of the swinging element 13 may cause the driving shaft 12 to shake or to generate noise. In a preferred embodiment, anti-shock elements such as soft pad 135, a spring element 136, etc can be mounted between the root section 131 and the driving shaft 12 so as to effectively distribute and absorb the force of vibration.

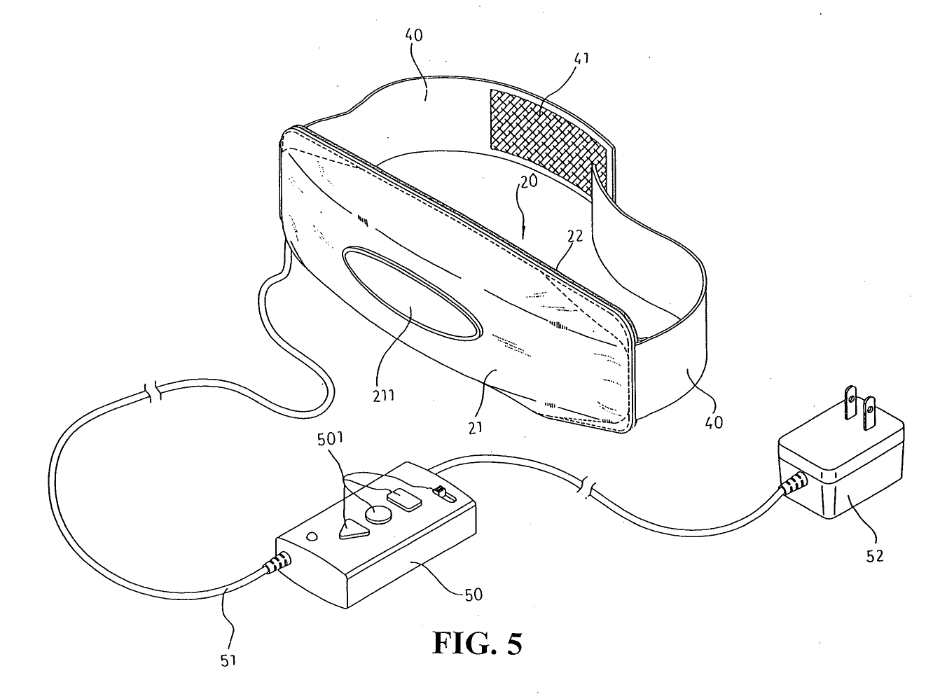

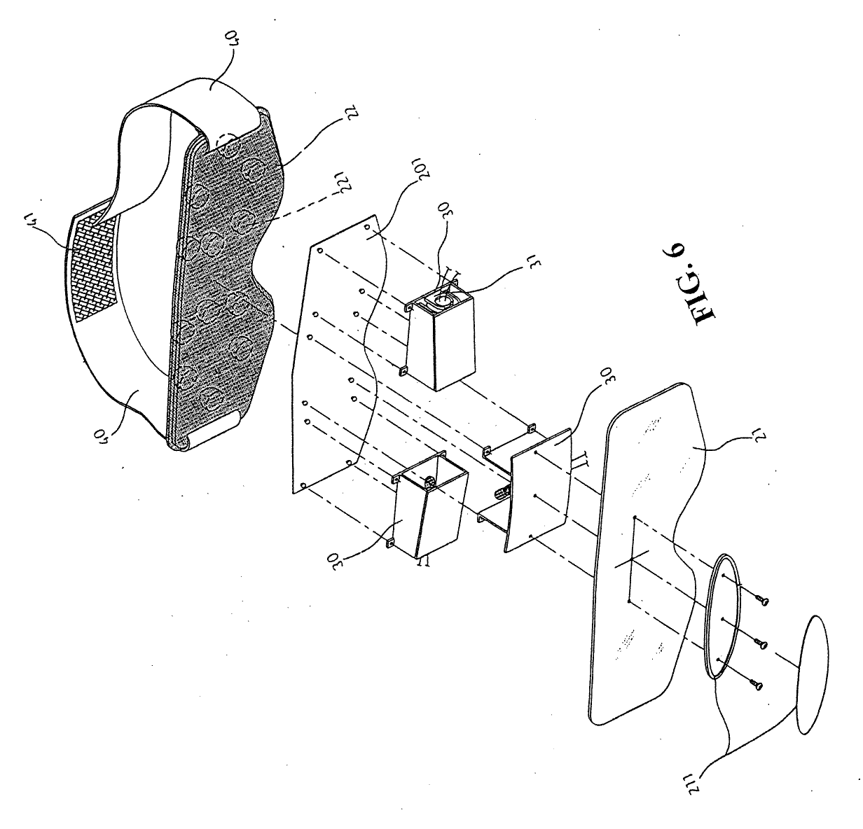

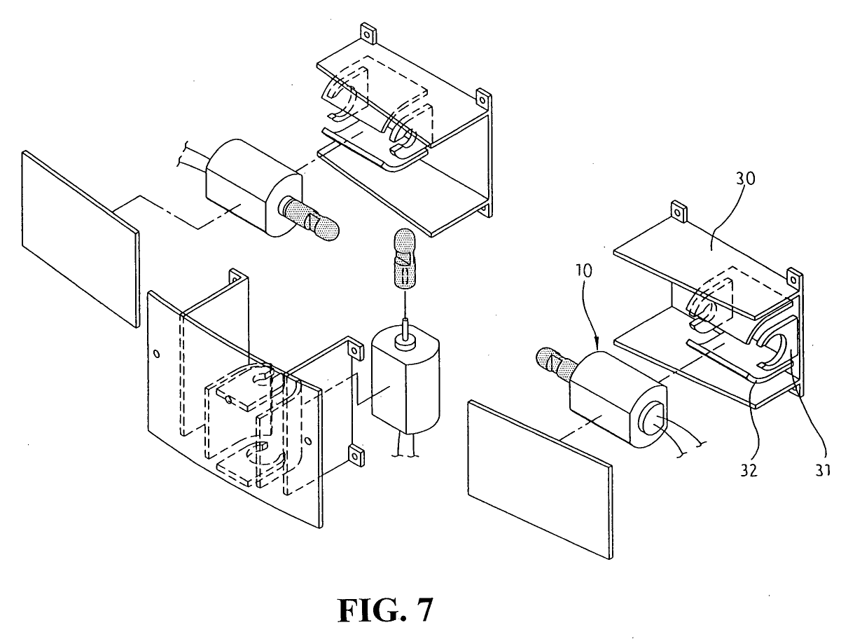

Referring to FIGS. 5 and 6, there is shown a massaging device having a mask body 20 formed from a front plate 21 and a rear plate 22. The material of the plates 21, 22 is soft fabric with flexibility. The front surface of the front plate 22 is provided with a backing plate 211 for decoration of trademark or advertising. A plurality of massaging protrusions 221 is provided at the rear surface of the rear plate 22 for massaging the eyes. A soft securing plate 201 is provided to the mask 20 for mounting the securing seat 30 and the centrifugal rotating power element 10. As shown in FIG. 7, there are also provided with a plurality of securing seats 30 to the massaging device and the material for the securing seat 30 is hard rigid material. The seats 30 can be arranged at the mask body 20 and each securing seat 30 is provided with two corresponding engaging frame 31 for direct mounting of the power element 10. There are two masking plates 32 used to protect the power element 10 and two binding strap 40 mounted at the two sides of the rear plates 32 and the strap 40 is provided with appropriate elasticity and adhesion fastener 41 so that the mask body 20 can be bound to the eye portions of the human body. A controller 50 is provided to the massaging device connected at one end of a conductive wire 51 and the mask body at the other end of the connection. The controller 50 contains a battery unit and a control circuit and the surface of the controller is provided with a plurality of control switches 501 which supplied power source to the power element 10. Thus the action and the force of massaging can be controlled. A transformer 52 is connected to the controller 50 for external connection.

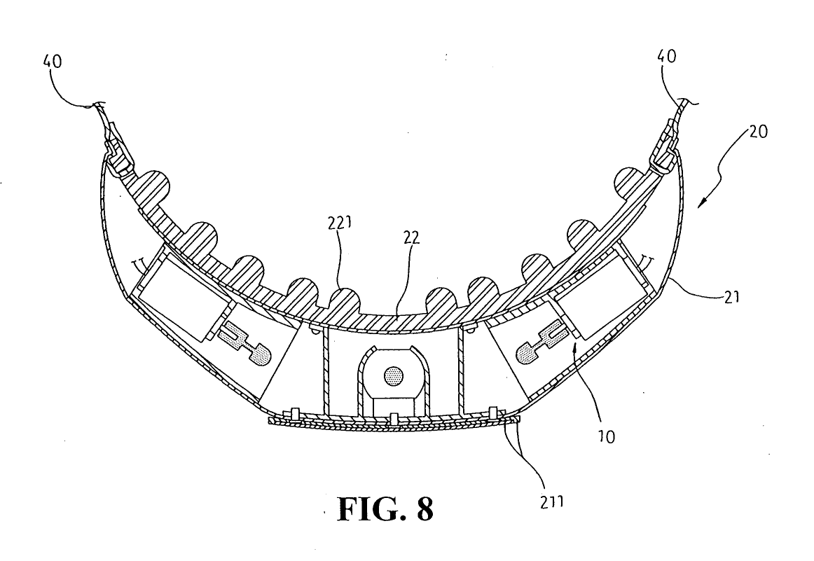

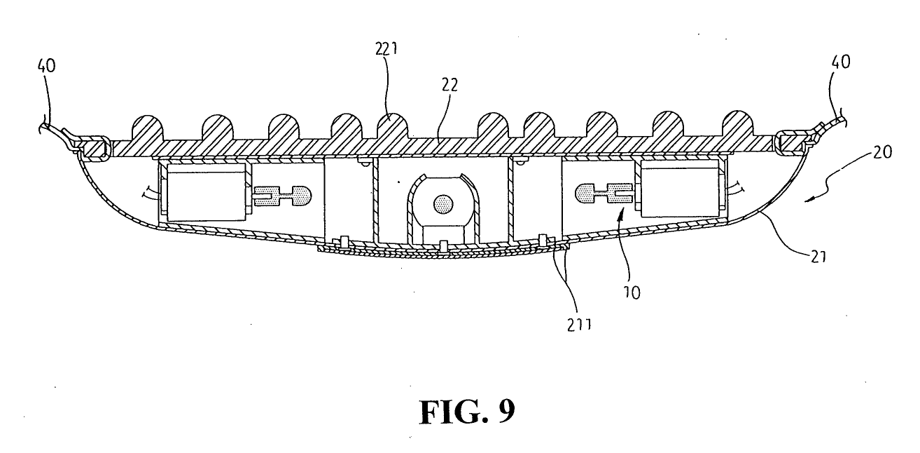

Referring to FIG. 8, the mask body 10 is made from resilient material and the shape can be changed appropriately and the mask body 10 can adhere onto the human eye portion and the mask body 10 can be placed down horizontally, referring to FIG. 9.

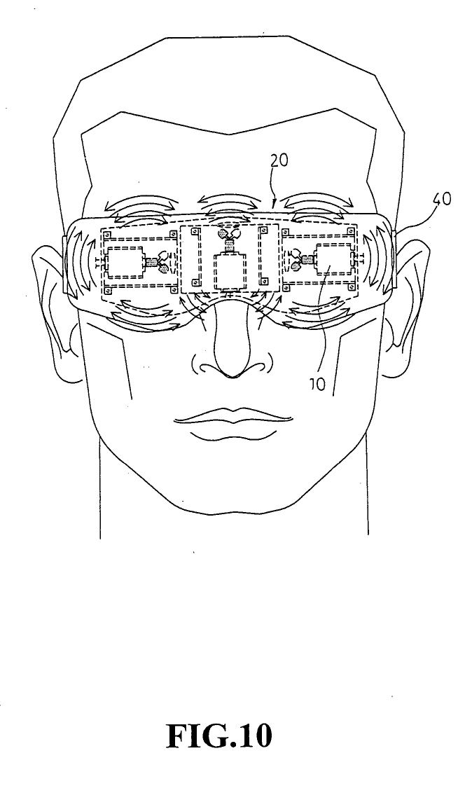

Referring to FIG. 10, the massaging device can be applied to the eye portion of the human body and there are three power elements. Two of the elements are provided at the sides of the mask body and are provided horizontally and there is one at the center which is in upright position. The circuit of the controller 50 and the control switch 501 are used to control such that the massaging is implemented as alternating vibration and the eyes experience a massaging effect. The controller 50 is used to adjust the force of massaging.

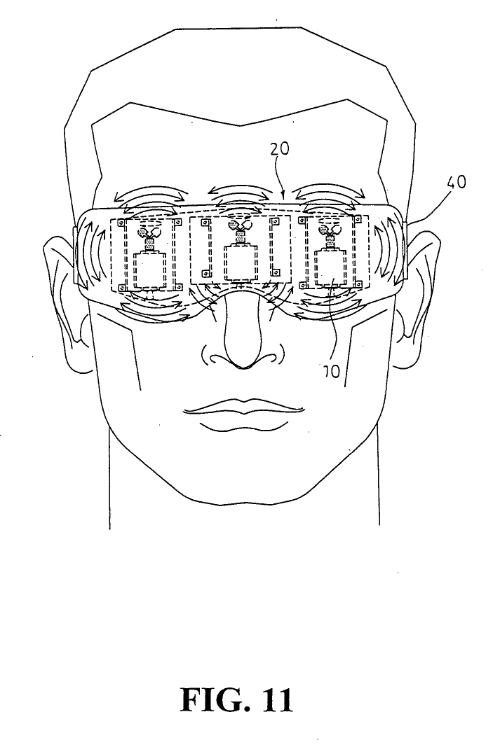

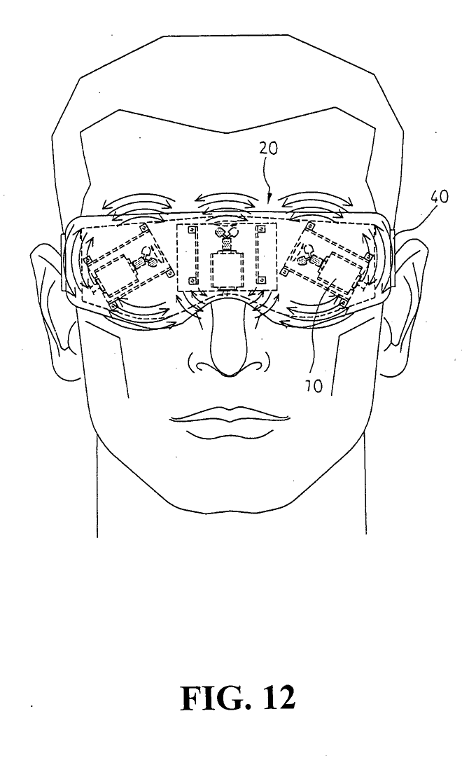

As shown in FIG. 11, all the power elements 10 are in upright position. In FIG. 12, the power elements 10 at the sides of the mask body 20 are in sloping position and the center one is in upright position. Similarly the eye portion is provided with massaging effect.

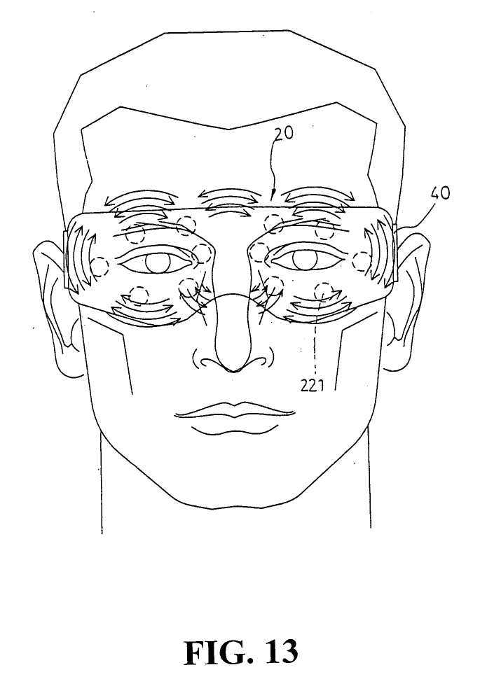

Referring to FIG. 13, as the rear surface of the mask body 20 is provided with a plurality of protrusions 221, the surrounding of the eyes portion is massaged so as to increase the blood circulation of the eye portion.

In view of the above description, the power element of the present invention provides a massaging effect similar to that of a vibration massaging device and the massaging force is adjustable. Besides, the power element is employed in the massaging device and the massaging device can be manufactured into a small size device.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A centrifugal, rotating power element comprising a motor having a driving shaft, characterized in that the driving shaft is provided with a swinging member having a root section and an end section and the weight of the root section and that of the end section are of certain ratio, and the root section and the end section are connected flexibly such that when the driving shaft rotates, the end portion of the swinging element is provided with an appropriate torsional swinging force as a result of the centrifugal force.

2. The centrifugal, rotating power element of claim 1, wherein the connection section of the end section and the root section of the swinging element is provided with a notch.

3. The centrifugal, rotating power element of claim 1, wherein the end section of the swinging element is provided with a screw hole for mounting with a weight body.

4. The centrifugal, rotating power element of claim 1, wherein the driving shaft between the root section of the swinging element and the motor is mounted with an anti-shock element.

5. The centrifugal, rotating power element of claim 4, wherein the anti-shock element is a soft pad.

6. The centrifugal, rotating power element of claim 4, wherein the anti-shock element is an elastic member.

7. A massaging device using the power element comprising a mask body having a front and a rear plate, a securing plate being mounted to the mask body for mounting a securing seat and the power element, and a plurality of securing seat mounted at the mask body for mounting a plurality of the power elements and two binding straps mounted at the two lateral sides of the rear plate of the mask body; and a controller having one end connected to a conductive wire and the mask body so as to provide power source to the power element and the controller controls the size of massaging force, the interior of the controller contained batteries and control circuit and the surface of the controller being a plurality of control switches and the controller connected to a transformer.

8. The massaging device of claim 7, wherein the front surface of the front plate of the hook body is provided with a binding plate.

9. The massaging device of claim 7, wherein the securing seat is provided with two corresponding engaging frame for securing the centrifugal, power element, and a masking plate to enhance the protection of the power element.

10. The massaging device of claim 7, wherein the front plate and the rear plate of the hood body and the securing plate are made from soft material.

11. The massaging device of claim 7, wherein the rear surface of the hood body is provided with protrusion corresponding to the acuputure point of the eyes.
